(19) United States
(12) Patent Application Publication
(10) Pub. No.: US 2008/0235045 A1
(43) Pub. Date: Sep. 25, 2008

(54) WORKFLOW MANAGEMENT SYSTEM

(76) Inventors: Takeshi Suzuki, Kanagawa (JP); Kaoru Maeda, Chiba (JP); Harald Holz, Kaiserslautern (DE); Oleg Rostanin, Kaiserslautern (DE)

Correspondence Address: DICKSTEIN SHAPIRO LLP, 1825 EYE STREET NW, Washington, DC, 20006-5403, US

(21) Appl. No.: 12/041,998

(22) Filed: Mar. 4, 2008

(30) Foreign Application Priority Data
Mar. 19, 2007 (JP) 2007-071602

(51) Int. Cl. G06Q 10/00

(52) U.S. Cl. 705/1

(57) ABSTRACT

A disclosed workflow management system dynamically formulates a workflow model at the time of executing a workflow. The workflow management system includes a unit configured to access the contents of an e-mail transmitted or received by a user of the workflow management system, and a unit configured to operate a task in the workflow management system based on the accessed contents of the e-mail.

### BACKGROUND OF THE INVENTION

1. Field of the Invention

The present invention relates to a workflow management system for dynamically formulating a workflow model at the time of executing a workflow.

2. Description of the Related Art

In conventional workflow management systems, a workflow model needs to be determined before executing the workflow. However, in fields such as research and development or in some service businesses, prior information is often incomplete. Therefore, it is difficult to formulate a workflow model in advance. Accordingly, a method called a constructive workflow has been developed, where a model can be dynamically formulated while executing a workflow (see, for example, Japanese Patent Application No. 2005-47792 and Japanese Patent Application No. 2005-154261).

With the above-described constructive workflow technology, predetermined workflow components (typical parts of a workflow) can be combined, thereby realizing dynamic definitions of the workflow.

Patent Document 1: Japanese Laid-Open Patent Application No. 2005-285101

The above-described workflow management system is advantageous in that it is capable of formulating a workflow with a high degree of freedom in accordance with the nature of the operation. However, although the degree of freedom is high, various operations need to be made for the workflow management system, which require time-consuming efforts.

### SUMMARY OF THE INVENTION

The present invention provides a workflow management system in which one or more of the above-described disadvantages are eliminated.

A preferred embodiment of the present invention provides a workflow management system with which operations for a task can be performed with the use of information in e-mails that are used by the user on a daily basis.

An embodiment of the present invention provides a workflow management system for dynamically formulating a workflow model at the time of executing a workflow, the workflow management system including a unit configured to access the contents of an e-mail transmitted or received by a user of the workflow management system; and a unit configured to perform operations for a task in the workflow management system based on said accessed contents of said e-mail.

An embodiment of the present invention provides a management method of a workflow management system for dynamically formulating a workflow model at the time of executing a workflow, the management method including a step of accessing the contents of an e-mail transmitted or received by a user of the workflow management system; and a step of performing operations for a task in the workflow management system based on said accessed contents of said e-mail.

According to one embodiment of the present invention, a workflow management system is provided, with which operations for various tasks can be performed with the use of information in e-mails that are used by the user on a daily basis, and convenience can be improved.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of a workflow management system according to an embodiment of the present invention;

FIG. 2 is a block diagram of an e-mail subsystem;

FIG. 3 illustrates an example of an implemented workflow management system;

FIG. 4 is a block diagram illustrating an example of a structure of a workflow;

FIG. 5 illustrates a sequence (part 1) of an example of a process for attaching a document based on an e-mail;

FIG. 6 is an example of header information of an e-mail;

FIG. 7 is an example of user group information;

FIG. 8 is an example of task instance data;

FIG. 9 is an example of user access history;

FIG. 10 illustrates a sequence (part 2) of another example of the process of attaching a document based on an e-mail;

FIG. 11 illustrates a sequence of an example of a process for performing access control based on an e-mail;

FIG. 12 illustrates a sequence of an example of a process for updating a task based on an e-mail;

FIG. 13 is an example of header information of an e-mail including an attached document;

FIG. 14 illustrates a sequence of an example of a process for creating a task based on an e-mail;

FIG. 15 is an example of a search word list;

FIG. 16 is an example of an e-mail for giving an instruction to create a task;

FIG. 17 is an example of a task creation instruction;

FIG. 18 indicates an example of a method for distinguishing whether a task has been created by the system; and

FIG. 19 illustrates an example of a displayed list of tasks.

### DETAILED DESCRIPTION OF THE PREFERRED EMBODIMENTS

A description is given, with reference to the accompanying drawings, of an embodiment of the present invention.

<System Configuration>

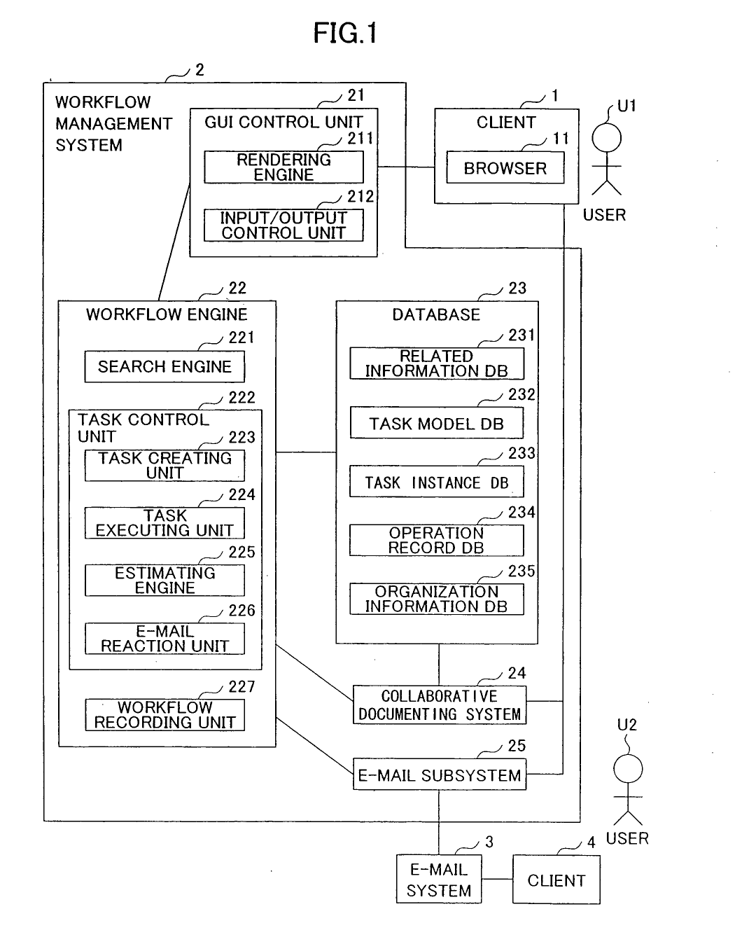

FIG. 1 is a block diagram of a workflow management system according to an embodiment of the present invention.

In FIG. 1, a workflow management system 2 includes a GUI control unit 21 that provides a GUI (Graphical User Interface) in response to access from a browser 11 of a client 1 such as a PC (Personal Computer) that is operated by a user U1 using the system, a workflow engine 22 that dynamically generates and executes a workflow model by reusing an existing task model and/or a task instance, a database 23 that holds information necessary for a process, a collaborative documenting system 24 including a CMS (Contents Management System) such as Wiki, and an e-mail subsystem 25 having an e-mail transmitting/receiving function. The e-mail subsystem 25 is connected to an external e-mail system 3, and a client 4 of a user U2 (may be the same person as user U1) is connected to the e-mail system 3.

The database 23 includes a related information DB 231 that holds related information referred to when executing a workflow, a task model DB 232 that holds a task model previously abstracted by an administrator, a task instance DB 233 that holds task instances, an operation record DB 234 that holds operational records of a workflow, and an organization information DB 235 that holds information on a user and a user group to which the user belongs. The task model DB 232 and the task instance DB 233 are linked with information loaded in the related information DB 231.

The GUI control unit 21 includes a rendering engine 211 for rendering a displayed page and an input/output control unit 212 for exchanging information with the user U1.

The workflow engine 22 includes a search engine 221 for executing various searches in the database 23; a task control unit 222 for controlling a task included in a workflow; and a workflow recording unit 227 for referring to the database 23, monitoring operations of the user U1 and the workflow management system 2, and recording operations of a workflow in the operation recording DB 234.

The task control unit 222 includes a task creating unit 223 for creating a task, a task executing unit 224 for executing a created task, an estimating engine 225 for estimating the present task of the user U1 based on information in the operation recording DB 234 and searching for related information in the database 23, and an e-mail reaction unit 226 for performing various operations with respect to a task in response to the contents of an e-mail that is transmitted/received by the e-mail subsystem 25.

A summary of the basic operations of controlling a workflow is given below. That is, the user U1 operates the workflow engine 22 through the input/output control unit 212 of the GUI control unit 21. Specific operations include creating a workflow, executing a workflow, creating a workflow model, loading related information and documents, and linking these with a workflow instance and/or a workflow model.

When creating a workflow, the search engine 221 of the workflow engine 22 executes various searches in the database 23.

The task control unit 222 of the workflow engine 22 uses the task model DB 232 and the task instance DB 233 to control a task based on instructions from the user U1. The task creating unit 223 of the task control unit 222 creates a task based on information in the database 23 according to instructions from the user U1, and performs operations such as linking the information. The task executing unit 224 uses information in the task instance DB 233 according to instructions from the user U1, and updates the actual task information (from the system's viewpoint, execution of a task corresponds to updating task information). The estimating engine 225 estimates the present task of the user U1 based on information in the operation recording DB 234, and searches for related information in the database 23.

The workflow recording unit 227 monitors operations of the user U1 and the workflow management system 2, and loads operational records of a workflow in the operation recording DB 234.

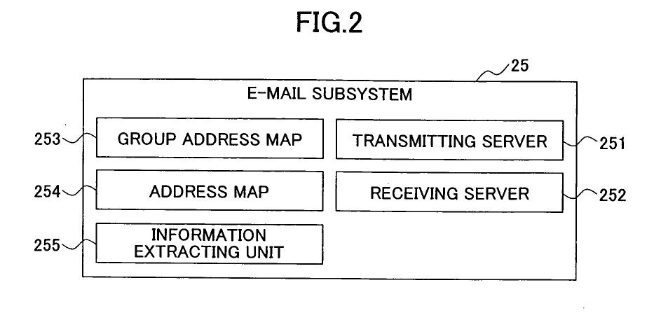

FIG. 2 is a block diagram of the e-mail subsystem 25. The e-mail subsystem 25 includes a transmitting server 251 for performing a transmitting process of an e-mail, a receiving server 252 for performing a receiving process of an e-mail, a group address map 253 for managing group addresses, an address map 254 for managing individual addresses, and an information extracting unit 255 for extracting information from the header or the main body of an e-mail in response to a request from the workflow engine 22 (FIG. 1).

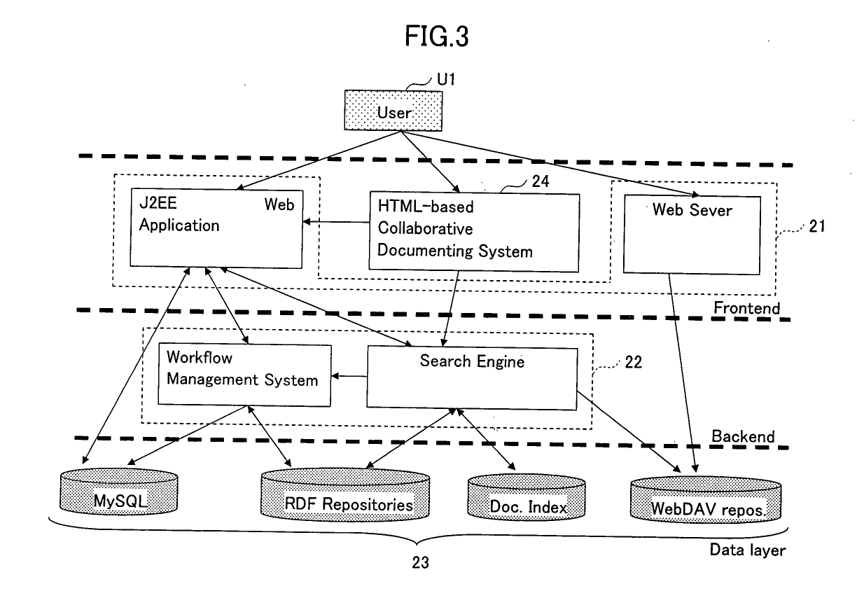

FIG. 3 illustrates an example of an implemented workflow management system 2. Web Server and J2EE Web Application correspond to the GUI control unit 21, and HTML-based Collaborative Documenting System corresponds to the collaborative documenting system 24. These units form the Frontend. That is, the Web Server and the HTML-based Collaborative Documenting System are provided so that the user U1 can access the system with the use of a Web browser (browser 11). Moreover, in this implementation, it is assumed that the user U1 accesses the system using the Web browser, and therefore it is necessary to manage access to a file in a network. In this example, it is assumed that this function is realized with the use of a file management system in a network such as NetDrive.

Furthermore, a Workflow Management System and a Search Engine correspond to the workflow engine 22, which form the Backend. The basic functions of workflow management are the same as those of conventional systems, and therefore the system according to an embodiment of the present invention can include an engine of a typical workflow management system. Furthermore, with regard to the search engine searching for tasks and related information, a typical search engine based on a query can be used.

Furthermore, MySQL, RDF Repositories, Doc.Index, and WebDAVrepos. correspond to the database 23 and form the Data layer. Task information and related information are managed as RDF repositories. Related information is managed with a document repository and an index server. The former corresponds to the task model DB 232 and the task instance DB 233, and the latter corresponds to the related information DB 231. User information and organization information are similarly realized by RDF repositories. Both of these correspond to the organization information DB 235 shown in FIG. 1.

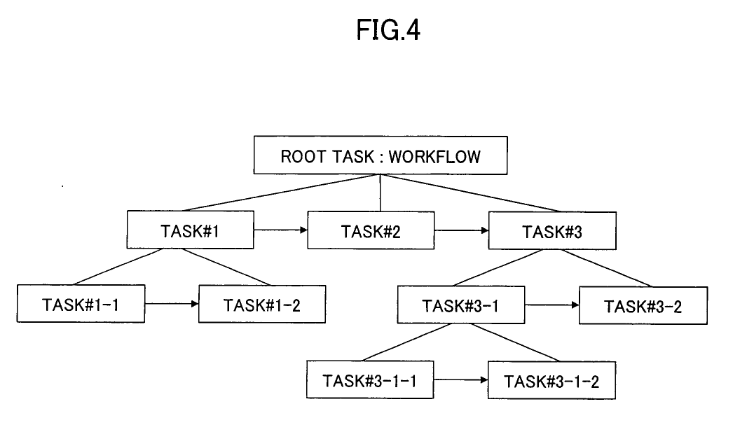

FIG. 4 is a block diagram illustrating an example of a structure of a workflow. In FIG. 4, a workflow corresponding to a root task includes an arbitrary number of tasks. Each of the tasks further includes an arbitrary number of sub-tasks, so that a hierarchy is formed. Thus, a workflow can include plural tasks, each task can include plural sub-tasks, and their order relationship (indicated by arrows in FIG. 4) is the same as a typical workflow management system. Furthermore, each task and sub-task can hold related information and related documents.

A task instance corresponds to a task as an entity that is individually managed, and a task model or a process type corresponds to a model with a high level of abstraction, which acts as a format of a task instance.

<Attachment of Document Based on E-Mail>

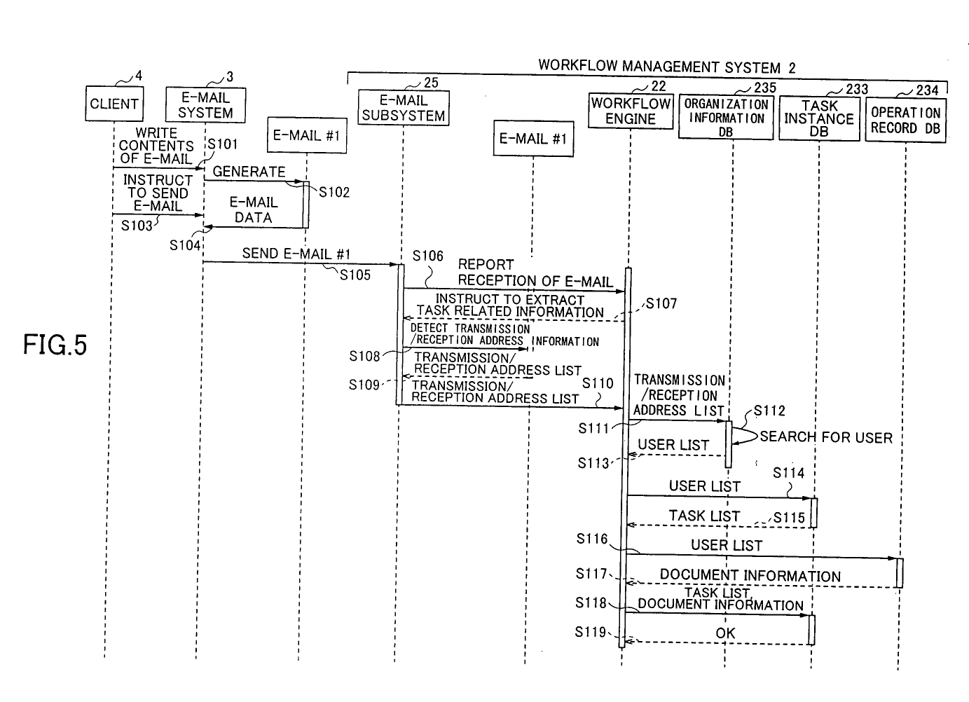

FIG. 5 illustrates a sequence of an example of a process for attaching a document based on an e-mail.

Referring to FIG. 5, when the user U2 writes the contents of an e-mail from the client 4 into the e-mail system 3 (step S101), the e-mail system 3 generates an e-mail #1 (step S102).

Subsequently, when the user U2 gives an instruction from the client 4 to the e-mail system 3 to send the e-mail #1 (step S103), the e-mail system 3 acquires e-mail data of the e-mail #1 (step S104), and sends it to the e-mail subsystem 25 of the workflow management system 2 (step S105).

The e-mail subsystem 25 reports to the workflow engine 22 that the e-mail #1 has been received (step S106), and the workflow engine 22 instructs the e-mail subsystem 25 to extract task related information (step S107).

Upon receiving this instruction, the e-mail subsystem 25 detects transmission/reception address information from the received e-mail #1 (step S108), acquires a transmission/reception address list (step S109), and passes it to the workflow engine 22 (step S110). A typical matching method can be used to detect the transmission/reception address information.

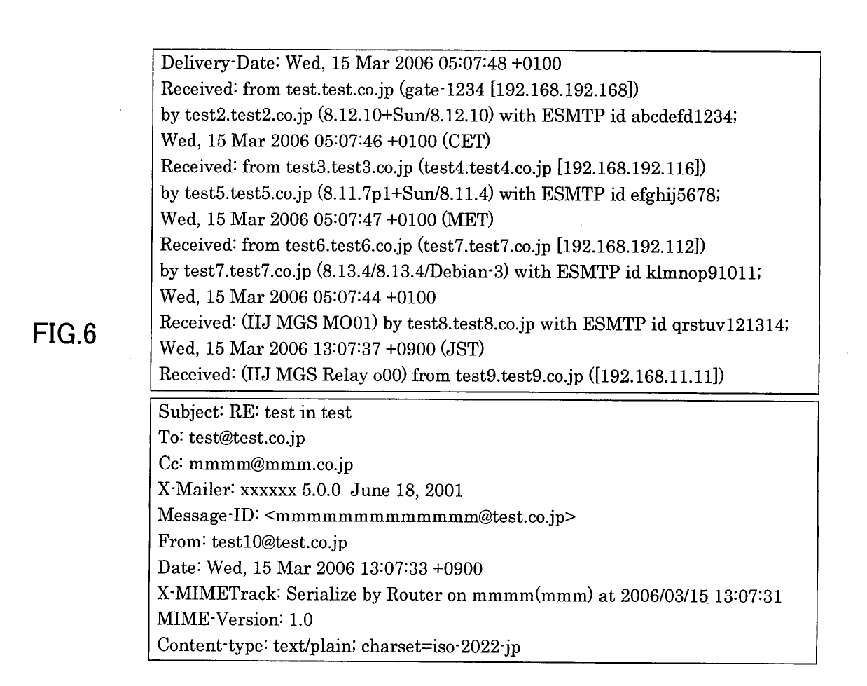

FIG. 6 is an example of header information of an e-mail. The top layer includes route information and the bottom layer includes transmission/reception information. In this example, the following is extracted from the transmission/reception information in the bottom layer to form the transmission/reception address list.
From: test10@test.co.jp
To: test@test.co.jp
Cc: mmmm@mmm.co.jp

Referring back to FIG. 5, the workflow engine 22 uses the acquired transmission/reception address list to search for a user from the organization information DB 235 (steps S111, S112), and acquires a user list (step S113).

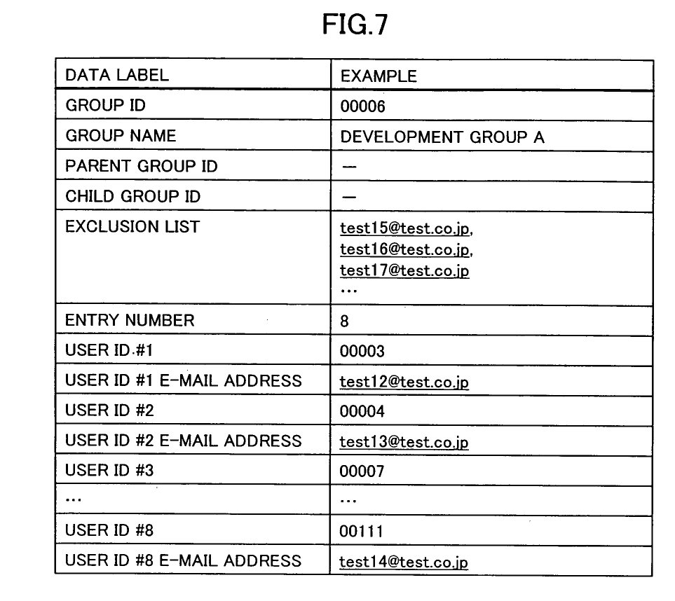

FIG. 7 is an example of user group information in the organization information DB 235, including items such as “group ID”, “group name”, “parent group ID”, “child group ID”, “exclusion list”, “entry number”, “user ID #1”, and “user ID #1 e-mail address”. The user group can be a group of a particular organization or a small and fluid group formed in units of projects.

In this case, the user ID is identified from the e-mail address to form a user list.

Referring back to FIG. 5, the workflow engine 22 acquires, based on the transmission user (user who transmitted the e-mail) in the user list, a task list of tasks of which the corresponding user is to become the task owner, from the task instance DB 233 (steps S114, S115).

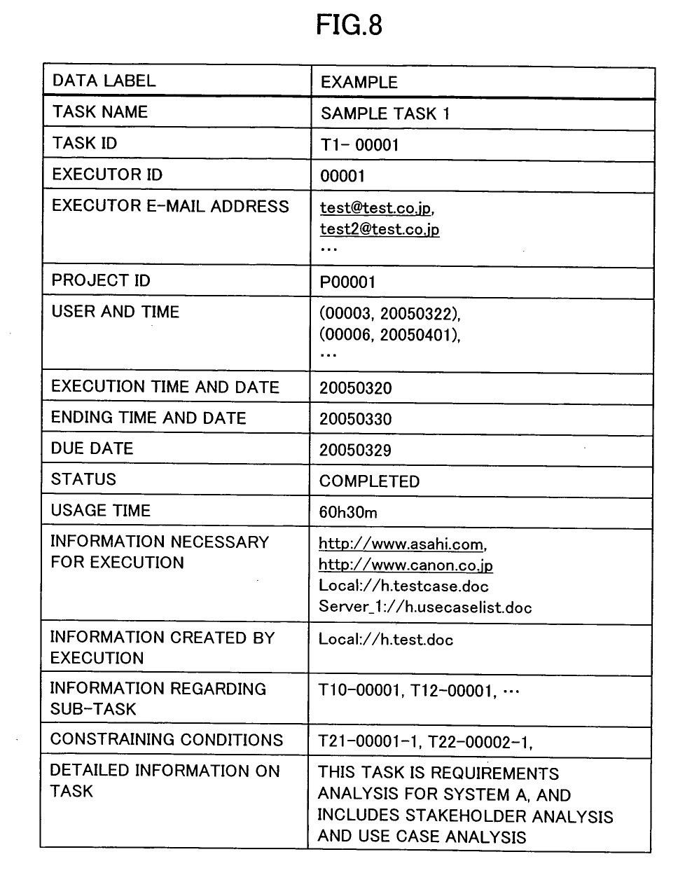

FIG. 8 is an example of task instance data, including items such as “task name”, “task ID”, “executor ID”, “executor e-mail address”, “project ID”, “user and time”, “execution time and date”, “ending time and date”, “due date”, “status”, “usage time”, “information necessary for execution”, “information created by execution”, “information regarding sub-task”, “constraining conditions”, and “detailed information on task”. Information regarding the e-mail address can be managed in a database of another data layer. The executor e-mail address can have plural entries.

In this example, the “executor e-mail address” is searched for to form a task list with the task ID corresponding to the transmission user.

Referring back to FIG. 5, the workflow engine 22 acquires, based on the destination user (user for whom the e-mail is destined) from among users in the user list, document information that has been accessed (created, referred to (viewed), updated (corrected), etc.) by the corresponding user, from the operation record DB 234 (steps S116, S117). The operation of acquiring this document information (steps S116, S117) can be performed before the operation of acquiring the task list (steps S114, S115).

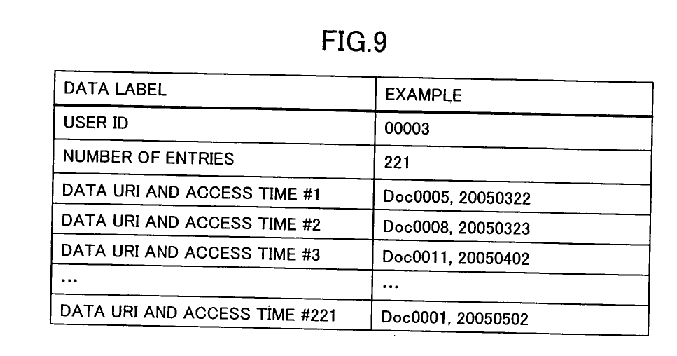

FIG. 9 is an example of user access history of the operation record DB 234, including items such as “user ID”, “number of entries”, and “data URI and access time #1”. The workflow engine 22 acquires the data URI of the document accessed from the corresponding user ID to form document information.

Referring back to FIG. 5, the workflow engine 22 attaches, to the task identified based on the transmission user in the task instance DB 233, the document identified with the destination user as a related document (steps S118, S119).

Generally, if a certain user creates a task, the certain user will contact another user related to the task by e-mail. Furthermore, documents accessed by the other user will have a high probability of being related to the task. By the above-described process, a document accessed by the destination user to whom the e-mail is sent is automatically attached to the task of the transmission user as a related document. Therefore, it is possible to reduce the burden on the user who is the task owner, and to provide useful information for executing the task. The document accessed by the transmission user can be automatically attached to the user's task as a related document in the system, without being triggered by an e-mail.

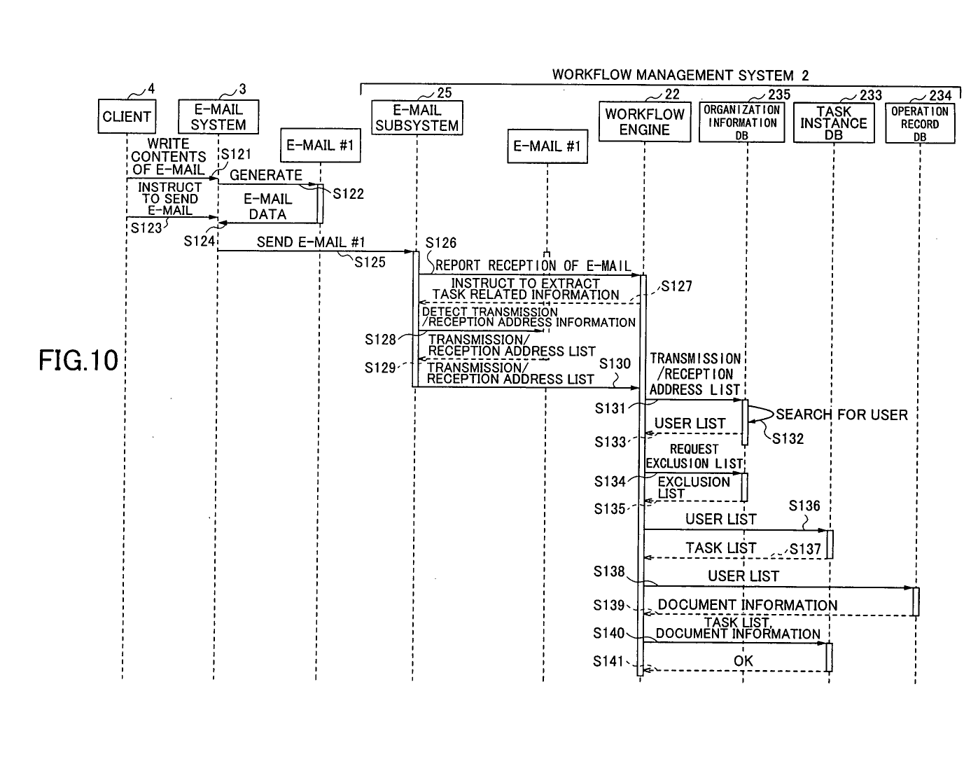

FIG. 10 illustrates a sequence of another example of the process of attaching a document based on an e-mail. To be prepared for a case where a user who is a task owner transfers the e-mail to a predetermined e-mail address, e-mail addresses included in the exclusion list are excluded from the destination e-mail addresses so that an unrelated document is not attached to the task as a related document.

Referring to FIG. 10, when the user U2 writes the contents of an e-mail from the client 4 into the e-mail system 3 (step S121), the e-mail system 3 generates an e-mail #1 (step S122).

Subsequently, when the user U2 gives an instruction from the client 4 to the e-mail system 3 to send the e-mail #1 (step S123), the e-mail system 3 acquires e-mail data of the e-mail #1 (step S124), and sends it to the e-mail subsystem 25 of the workflow management system 2 (step S125).

The e-mail subsystem 25 reports to the workflow engine 22 that the e-mail #1 has been received (step S126), and the workflow engine 22 instructs the e-mail subsystem 25 to extract task related information (step S127).

Upon receiving this instruction, the e-mail subsystem 25 detects transmission/reception address information from the received e-mail #1 (step S128), acquires a transmission/reception address list (step S129), and passes it to the workflow engine 22 (step S130).

The workflow engine 22 uses the acquired transmission/reception address list to search for a user from the organization information DB 235 (steps S131, S132), and acquires a user list (step S133).

Next, the workflow engine 22 acquires, from the organization information DB 235, an exclusion list corresponding to the transmission user (steps S134, S135). The exclusion list is included in the user group information shown in FIG. 7.

Next, the workflow engine 22 acquires, based on the transmission user (user who transmitted the e-mail) in the user list, a task list of tasks of which the corresponding user is to become the task owner, from the task instance DB 233 (steps S136, S137).

Next, the workflow engine 22 acquires, based on the destination user from among the users on the user list, document information that has been accessed (created, referred to (viewed), updated (corrected), etc.) by the corresponding user, from the operation record DB 234 (steps S138, S139). At this time, a destination user corresponding to an e-mail address in the exclusion list is excluded. The operation of acquiring this document information (steps S13B, S139) can be performed before the operation of acquiring the task list (steps S136, S137).

The workflow engine 22 attaches, to the task identified based on the transmission user in the task instance DB 233, the document identified with the destination user as a related document (steps S140, S141).

<Access Control Based on E-Mail>

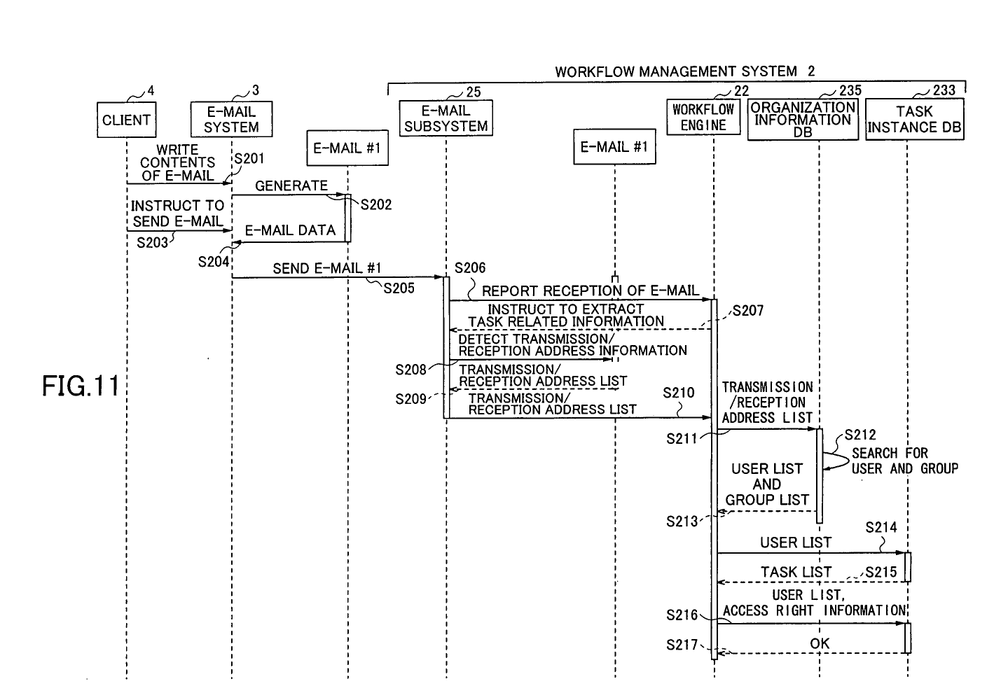

FIG. 11 illustrates a sequence of an example of a process for performing access control based on an e-mail.

Referring to FIG. 11, when the user U2 writes the contents of an e-mail from the client 4 into the e-mail system 3 (step S201), the e-mail system 3 generates an e-mail #1 (step S202).

Subsequently, when the user U2 gives an instruction from the client 4 to the e-mail system 3 to send the e-mail #1 (step S203), the e-mail system 3 acquires e-mail data of the e-mail #1 (step S204), and sends it to the e-mail subsystem 25 of the workflow management system 2 (step S205).

The e-mail subsystem 25 reports to the workflow engine 22 that the e-mail #1 has been received (step S206), and the workflow engine 22 instructs the e-mail subsystem 25 to extract task related information (step S207).

Upon receiving this instruction, the e-mail subsystem 25 detects transmission/reception address information from the received e-mail #1 (step S208), acquires a transmission/reception address list (step S209), and passes it to the workflow engine 22 (step S210). At this time, the e-mail subsystem 25 recognizes that the e-mail #1 is addressed to a group address based on associations between the group address map 253 and the address map 254 (FIG. 2). When a group address is included, the group address is broken down into individual addresses. When the group address is set in association with a group ID in the user group information (FIG. 7) in the organization information DB 235, the group address need not be broken down into individual addresses.

The workflow engine 22 uses the acquired transmission/reception address list to search for a user and a user group from the organization information DB 235 (steps S211, S212), and acquires a user list and a user group list (step S213). When plural user groups are detected, they can be displayed in a descending order of relevance ratios, or in an order according to e-mail addresses registered as executor addresses.

Next, the workflow engine 22 acquires, based on the transmission user in the user list, a task list of tasks for each of which the corresponding user is to become the task owner, from the task instance DB 233 (steps S214, S215).

Then, the workflow engine 22 gives an access right corresponding to the user group to a task identified based on the transmission user in the task instance DB 233 (steps S216, S217).

Generally, if a certain user creates a task, the certain user will contact another user related to the task by e-mail. If both users belong to a particular user group, it will be reasonable to perform access control based on the user group. By the above-described process, an access right corresponding to a user group will be automatically given to the task of the transmission user. Therefore, it is possible to reduce the burden on the user who is the task owner, and to give an appropriate access right to the task.

This access control can be performed together with the above-described process of attaching a related document to the task.

<Updating Task Based on E-Mail>

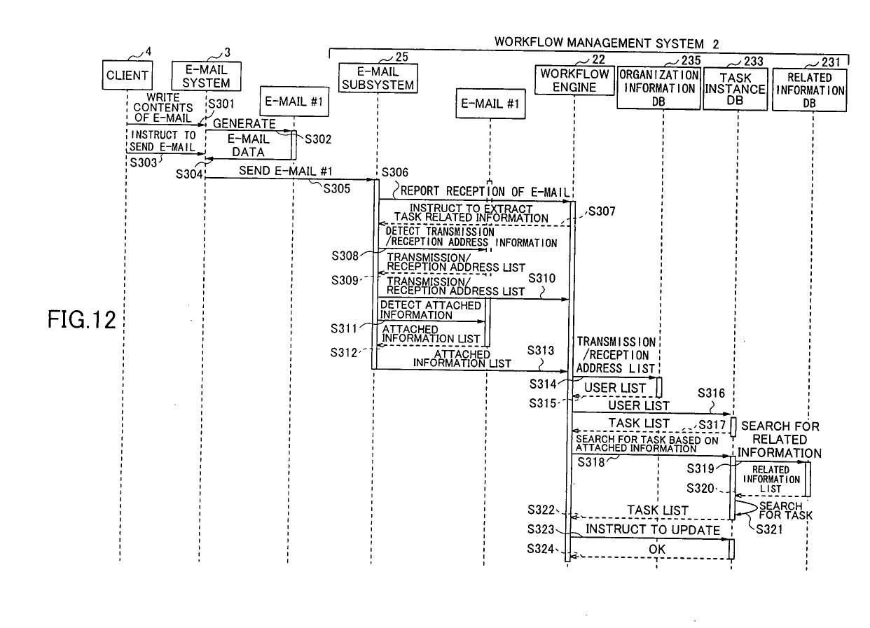

FIG. 12 illustrates a sequence of an example of a process for updating a task based on an e-mail.

Referring to FIG. 12, when the user U2 writes the contents of an e-mail from the client 4 into the e-mail system 3 (step S301), the e-mail system 3 generates an e-mail #1 (step S302).

Subsequently, when the user U2 gives an instruction from the client 4 to the e-mail system 3 to send the e-mail #1 (step S303), the e-mail system 3 acquires e-mail data of the e-mail #1 (step S304), and sends it to the e-mail subsystem 25 of the workflow management system 2 (step S305).

The e-mail subsystem 25 reports to the workflow engine 22 that the e-mail #1 has been received (step S306), and the workflow engine 22 instructs the e-mail subsystem 25 to extract task related information (step S307).

Upon receiving this instruction, the e-mail subsystem 25 detects transmission/reception address information from the received e-mail #1 (step S308), acquires a transmission/reception address list (step S309), and passes it to the workflow engine 22 (step S310).

The e-mail subsystem 25 detects attached information from the e-mail #1 (step S311), acquires an attached information list (step S312), and passes it to the workflow engine 22 (step S313).

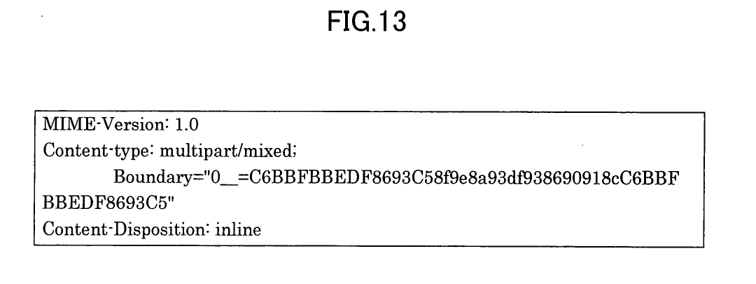

FIG. 13 is an example of header information of an e-mail including an attached document. The attached information is acquired from this header information.

Referring back to FIG. 12, the workflow engine 22 uses the acquired transmission/reception address list to search for a user from the organization information DB 235 (step S314), and acquires a user list (step S31S).

Next, the workflow engine 22 acquires, based on the transmission user in the user list, a task list of tasks of which the corresponding user is to become the task owner, from the task instance DB 233 (steps S316, S317).

Next, the workflow engine 22 requests the task instance DB 233 to search for a task based on the attached information (to perform a search by using the attached document as a query) (step S318). Related information is searched for in the related information DB 231 from the task instance DB 233 to acquire a related information list (steps S319, S320) A search for the task is conducted (step S321), and a list of tasks having the same or similar related information is acquired (step S322). A typical matching method can be used to conduct this search. The search can also be conducted by adding restrictions by an extension.

On the task that has been identified based on the transmission user, the workflow engine 22 makes various updates (e.g., adding related information) in the task instance DB 233 based on other task information identified from the attached information (steps S323, S324).

Generally, another task having the same or similar attached information will include useful information that needs to be referred to. Therefore, by updating a task based on information included in this other task it is possible to reduce the burden on the user who is the task owner, and to provide useful information for executing the task.

<Creating Task Based on E-Mail>

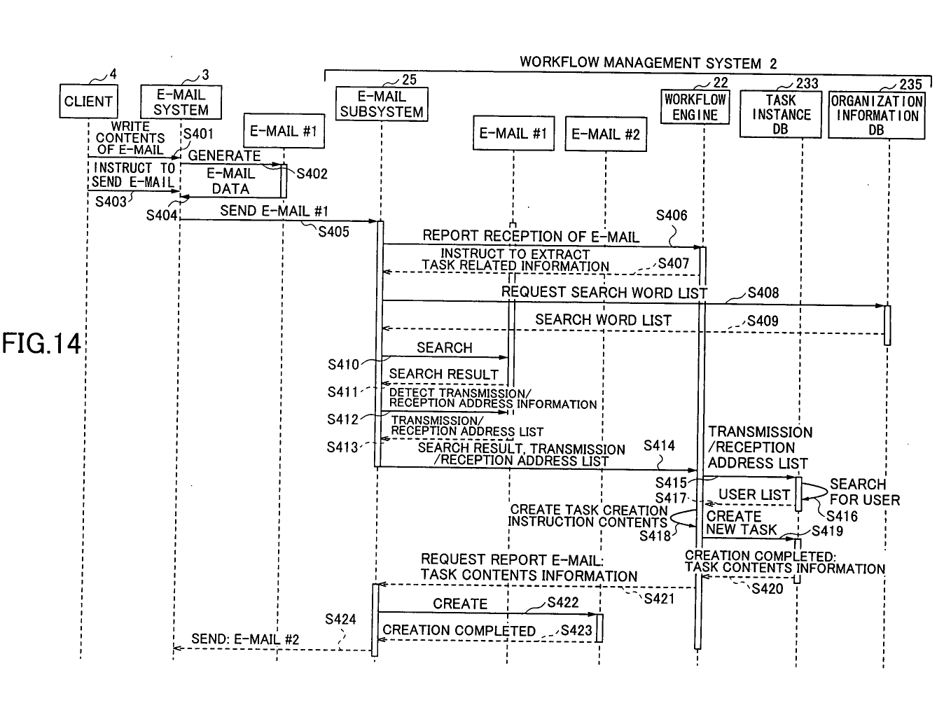

FIG. 14 illustrates a sequence of an example of a process for creating a task based on an e-mail.

Referring to FIG. 14, when the user U2 writes the contents of an e-mail from the client 4 into the e-mail system 3 (step S401), the e-mail system 3 generates an e-mail #1 (step S402).

Subsequently, when the user U2 gives an instruction from the client 4 to the e-mail system 3 to send the e-mail #1 (step S403), the e-mail system 3 acquires e-mail data of the e-mail #1 (step S404), and sends it to the e-mail subsystem 25 of the workflow management system 2 (step S405).

The e-mail subsystem 25 reports to the workflow engine 22 that the e-mail #1 has been received (step S406), and the workflow engine 22 instructs the e-mail subsystem 25 to extract task related information (step S407).

Upon receiving this instruction, the e-mail subsystem 25 acquires a search word list from the organization information DB 235 (steps S408, S409).

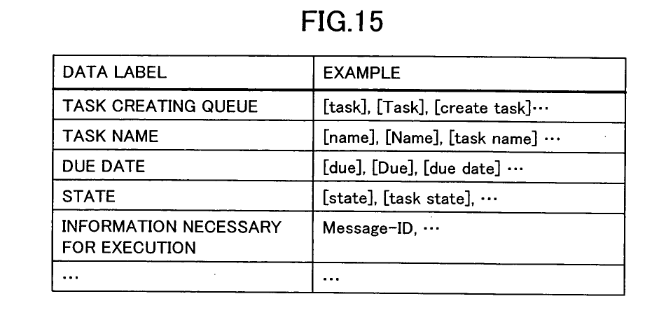

FIG. 15 is an example of a search word list. In the list, [task], [Task], [create task], etc., are set as task creating queues; [name], [Name], [task name], etc., are set as task names; [due], [Due], [due date], etc., are set as due dates; and [state], [task state], etc., are set as states.

Referring back to FIG. 14, the e-mail subsystem 25 searches the e-mail #1 based on the search word list (step S410), and obtains search results (step S411).

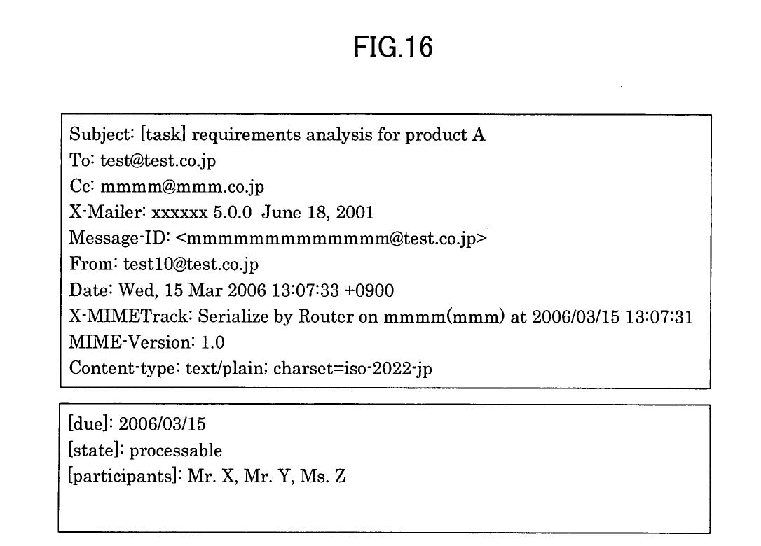

FIG. 16 is an example of an e-mail for giving an instruction to create a task. The following are extracted based on the search word list.
[task] requirements analysis for product A
[due]: Mar. 15, 2006
[state]: processable

Referring back to FIG. 14, the e-mail subsystem 25 detects transmission/reception address information from the received e-mail #1 (step S412), acquires a transmission/reception address list (step S413), and passes the search results mentioned above and the transmission/reception address list to the workflow engine 22 (step S414).

The workflow engine 22 uses the acquired transmission/reception address list to search for a user in the organization information DB 235 (steps S415, S416), and acquires a user list (step S417).

The workflow engine 22 creates task creation instruction contents based on the user list and the search results (step S418), creates a new task in the task instance DB 233 (step S419), and receives a report that the creating operation has been completed together with task contents information (step S420).

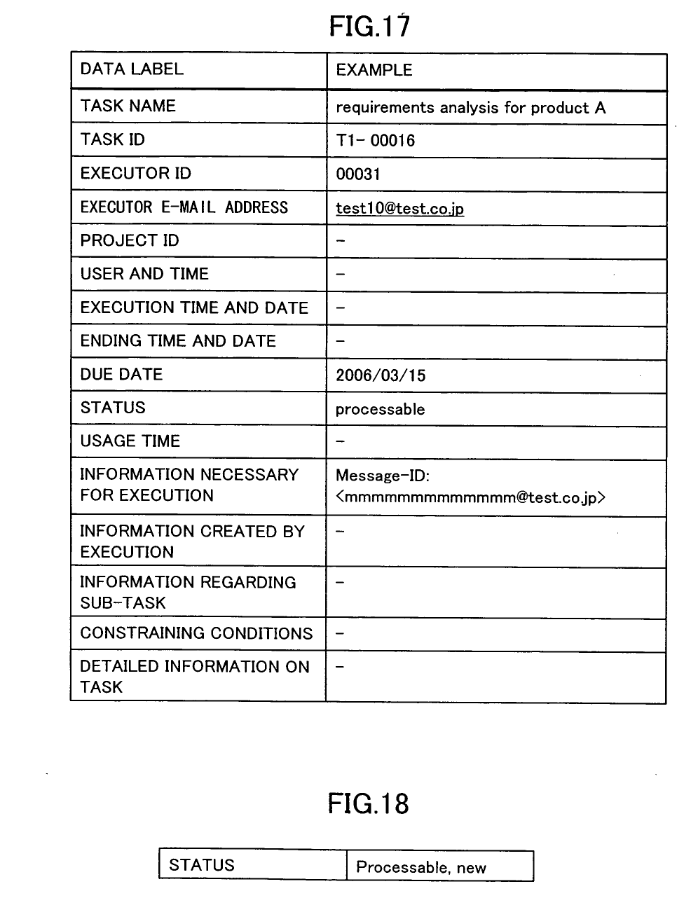

FIG. 17 is an example of the task creation instruction. In the task creation instruction, “requirements analysis for product A” obtained with the search word [task] is input as the “task name”, a symbol string (e.g., a serial name can be given to the tasks managed by the system) is automatically input as the “task ID” based on predetermined rules, a user ID acquired from the transmission source e-mail address is input as the “executor ID”, the transmission source address is input as the “executor e-mail address”, “2006/03/15” obtained with the search word [due] is input as the “due date”, “processable” obtained with the search word [state] is input as the “state”, and “<mmmmmmmmmmmmm@test.co.jp>” obtained with the search word Message-ID is input as a link for “information necessary for execution”. There is a blank (null) for “project ID”, “user and time”, “execution time and date”, “ending time and date”, “usage time”, “information created by execution”, “information regarding sub-task”, “constraining conditions”, and “detailed information on task”.

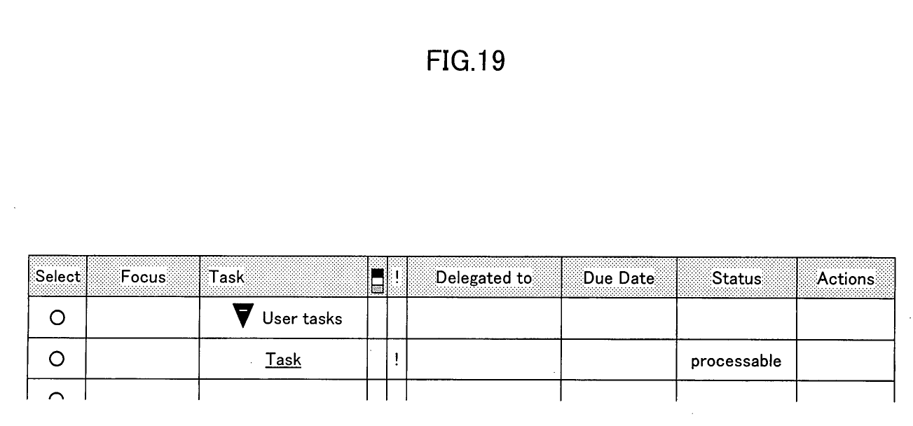

FIG. 18 indicates an example of a method for distinguishing whether a task has been created by the system. By inserting “new”, which indicates that the task has been created by the system, as “state” in the task instance data (FIG. B), it is possible to distinguish the task from a task created by regular user operations. It is also possible to separately provide a data label of “automatic creation flag” in the task instance data, and the “automatic creation flag” can be set as “1” if the task has been created by the system. FIG. 19 illustrates an example of a displayed list of tasks. The user's attention can be attracted by indicating “!” in the middle in accordance with the above-described “new”.

Referring back to FIG. 14, the workflow engine 22 requests the e-mail subsystem 25 to send a report e-mail that the task has been created together with task contents information (step S421). The e-mail subsystem 25 creates an e-mail #2 (including task contents information) for making the report (steps S422, S423), and sends it to the external e-mail system 3 (step S424). In this case, the destination of the report e-mail can be determined with the use of a separately-set option. For example, the destination of the report e-mail can be only the e-mail address of the user who made the task creation instruction, all users related to the task, or only particular users among them.

In the example of FIG. 14, a task is automatically generated upon receiving an e-mail; however, it is also possible to give an instruction to create a task upon designating an e-mail from among a list of e-mails, and the task can be created upon receiving this instruction. For example, when designating an e-mail among a list of e-mails with a mouse, a context menu can be displayed by right-clicking the mouse. A “task creation” command among the menu commands can be displayed, and the task can be created in the event that the “task creation” command is selected.

In the case where an IMAP e-mail system is used, there is a function of moving or copying a received e-mail to a particular folder according to a predetermined sorting rule, when the e-mail received by a reception server includes a particular destination or a particular word in its title or main body. By using this function, a task can be created with a process similar to the above by using information in the e-mail that has been moved or copied to the particular folder, such as information in the header, the tile, or the main body.

In this manner, a task can be created with the use of an e-mail, and therefore, even if the user cannot directly access the workflow management system 2, the user will be able to easily create a task. Furthermore, by receiving a report e-mail, the user can immediately know the task generation results.

According to one embodiment of the present invention, a workflow management system dynamically formulates a workflow model at the time of executing a workflow, and the workflow management system includes a unit configured to access the contents of an e-mail transmitted or received by a user of the workflow management system; and a unit configured to operate a task in the workflow management system based on said accessed contents of said e-mail.

Additionally, the workflow management system further includes a unit configured to identify a first user from a transmission source address of said e-mail and identify the task of the first user; a unit configured to identify a second user from a destination address of said e-mail and identify a document accessed by the second user; and a unit configured to add the identified document to the identified task.

Additionally, in the workflow management system, when identifying the second user from the destination address of said e-mail, if the destination address is included in an exclusion list, the second user will not be identified.

Additionally, the workflow management system further includes a unit configured to identify a first user from a transmission source address of said e-mail and identify the task of the first user; a unit configured to identify a user group to which a second user belongs from a destination address of said e-mail; and a unit configured to give an access right, which corresponds to the identified user group, to the identified task.

Additionally, the workflow management system further includes a unit configured to identify a first user from a transmission source address of said e-mail and identify the task of the first user; a unit configured to identify, based on a first document attached to said e-mail, a second task accompanied with a second document that is similar to the first document; and a unit configured to update the task of the first user based on information of the identified second task.

Additionally, the workflow management system further includes a unit configured to create a new task based on a predetermined word included in said e-mail.

Additionally, in the workflow management system, the new task is created in response to an instruction to create the new task being given, which instruction is given with a context menu displayed where an e-mail document is selected from an e-mail document list.

Additionally, in the workflow management system, the new task is created for an e-mail classified for a predetermined folder.

Additionally, in the workflow management system, the created new task is displayed in such a manner as to be distinguishable from the other tasks.

Additionally, the workflow management system further includes a unit configured to send a report that the new task has been created, to a user who is an owner of the created new task.

Additionally, the workflow management system can be configured as a workflow management method.

The present invention is not limited to the specifically disclosed embodiment, and variations and modifications may be made without departing from the scope of the present invention.

The present application is based on Japanese Priority Patent Application No. 2007-071602, filed on Mar. 19, 2007, the entire contents of which are hereby incorporated by reference.

What is claimed is:

1. A workflow management system for dynamically formulating a workflow model at the time of executing a workflow, the workflow management system comprising:
a unit configured to access the contents of an e-mail transmitted or received by a user of the workflow management system; and
a unit configured to perform operations for a task in the workflow management system based on said accessed contents of said e-mail.

2. The workflow management system according to claim 1, further comprising:
a unit configured to identify a first user from a transmission source address of said e-mail and identify the task of the first user;
a unit configured to identify a second user from a destination address of said e-mail and identify a document accessed by the second user; and
a unit configured to add the identified document to the identified task.

3. The workflow management system according to claim 2, wherein:
when identifying the second user from the destination address of said e-mail, if the destination address is included in an exclusion list, the second user will not be identified.

4. The workflow management system according to claim 1, further comprising:
a unit configured to identify a first user from a transmission source address of said e-mail and identify the task of the first user;
a unit configured to identify a user group to which a second user belongs from a destination address of said e-mail; and
a unit configured to give an access right, which corresponds to the identified user group, to the identified task.

5. The workflow management system according to claim 1, further comprising:
a unit configured to identify a first user from a transmission source address of said e-mail and identify the task of the first user;
a unit configured to identify, based on a first document attached to said e-mail, a second task accompanied by a second document that is similar to the first document; and
a unit configured to update the task of the first user based on information of the identified second task.

6. The workflow management system according to claim 1, further comprising:
a unit configured to create a new task based on a predetermined word included in said e-mail.

7. The workflow management system according to claim 6, wherein:
the new task is created in response to an instruction to create the new task being given, which instruction is given with a context menu displayed where an e-mail document is selected from an e-mail document list.

8. The workflow management system according to claim 6, wherein:
the new task is created for an e-mail classified for a predetermined folder.

9. The workflow management system according to claim 6, wherein:
the created new task is displayed in such a manner as to be distinguishable from the other tasks.

10. The workflow management system according to claim 6, further comprising:
a unit configured to send a report that the new task has been created, to a user who is an owner of the created new task.

11. A management method of a workflow management system for dynamically formulating a workflow model at the time of executing a workflow, the management method comprising:
a step of accessing the contents of an e-mail transmitted or received by a user of the workflow management system; and
a step of performing operations for a task in the workflow management system based on said accessed contents of said e-mail.

12. The management method according to claim 11, further comprising:
a step of identifying a first user from a transmission source address of said e-mail and identifying the task of the first user;
a step of identifying a second user from a destination address of said e-mail and identifying a document accessed by the second user; and
a step of adding the identified document to the identified task.

13. The management method according to claim 12, wherein:
when identifying the second user from the destination address of said e-mail, if the destination address is included in an exclusion list, the second user will not be identified.

14. The management method according to claim 11, further comprising:
a step of identifying a first user from a transmission source address of said e-mail and identifying the task of the first user;
a step of identifying a user group to which a second user belongs from a destination address of said e-mail; and
a step of giving an access right, which corresponds to the identified user group, to the identified task.

15. The management method according to claim 11, further comprising:
a step of identifying a first user from a transmission source address of said e-mail and identifying the task of the first user;
a step of identifying, based on a first document attached to said e-mail, a second task accompanied by a second document that is similar to the first document; and
a step of updating the task of the first user based on information of the identified second task.

16. The management method according to claim 11, further comprising:
a step of creating a new task based on a predetermined word included in said e-mail.

17. The management method according to claim 16, wherein:
the new task is created in response to an instruction to create the new task being given, which instruction is given with a context menu displayed where an e-mail document is selected from an e-mail document list.

18. The management method according to claim 16, wherein:
the new task is created for an e-mail classified for a predetermined folder.

19. The management method according to claim 16, wherein:
the created new task is displayed in such a manner as to be distinguishable from the other tasks.

20. The management method according to claim 16, further comprising:
a step of sending a report that the new task has been created, to a user who is an owner of the created new task.
